(19) United States
(12) Patent Application Publication
(10) Pub. No.: US 2013/0228401 A1
(43) Pub. Date: Sep. 5, 2013

(54) VIBRATION DAMPER HAVING A SENSOR DEVICE

(71) Applicants: Burkhard Bender, Windeck (DE); Wolfgang Hertz, Sankt Augustin (DE); Guido Holtmann, Windeck (DE)

(72) Inventors: Burkhard Bender, Windeck (DE); Wolfgang Hertz, Sankt Augustin (DE); Guido Holtmann, Windeck (DE)

(73) Assignee: ZF Friedrichshafen AG, Friedrichshafen (DE)

(21) Appl. No.: 13/885,767

(22) PCT Filed: Nov. 17, 2011
(86) PCT No.: PCT/EP11/70364

§ 371 Date: May 16, 2013

(30) Foreign Application Priority Data
Nov. 20, 2010 (DE) 10 2010 052 092.6

(51) Int. Cl. F16F 9/32; F16F 9/06

(52) U.S. Cl. CPC F16F 9/3292; F16F 9/06
USPC 188/1.11 R

(57) ABSTRACT

A vibration damper (1) has a sensor device (27), including a cylinder (3) which is filled with damping medium and in which a piston rod (5) is guided so as to be axially movable, wherein the vibration damper has a compensation chamber (13) which receives at least the damping medium volume displaced by the piston rod, wherein the sensor device has a first sensor component (29) which is stationary with respect to the cylinder and has a component (17) which carries out a movement synchronous with the piston rod, wherein a floating body (17) floats on a damping medium surface (19), and the floating body constitutes the sensor component that carries out a movement synchronous with the piston rod.

### PRIORITY CLAIM

This is a U.S. national stage of application No. PCT/EP2011/070364, filed on Nov. 17, 2011. Priority is claimed on the following application: Country: Germany, Application No.: 10 2010 052 092.6, Filed: Nov. 20, 2010, the content of which is/are incorporated here by reference.

### FIELD OF THE INVENTION

The invention is directed to a vibration damper having a sensor device.

### BACKGROUND OF THE INVENTION

A sensor device is used in many applications connected with a vibration damper to detect a movement parameter, e.g., the compression position, piston rod speed or wheel acceleration. In so doing, the vibration damper serves as a support for the sensor device. One component of the sensor device is at a structural component part on the piston rod side and one component is at a structural component part on the cylinder side. Regardless of the specific type of construction of the sensor device, at least one component is constructed so as to be as long as the stroke of the piston rod. Reference is made, for example, to DE 34 30 045. Alternatively, U.S. Pat. No. 5,451,870 is also cited as an example.

The axial length of the sensor device has a very substantial effect on price. Further, it entails a disadvantage in terms of installation space. In level control installations, it is already known that only a section of the piston rod stroke is detected. A piston rod position outside of the stroke range is determined simply as a piston rod that is moved in particularly far or moved out particularly far. The exact position is not important because in a level control system the sensed region of the piston rod stroke is reached again by supplying or removing operating medium. This solution, while more economical than sensing the piston rod stroke in its entirety, is not comparable in terms of quality. When the sensor device is applied in an adjustable vibration damper without leveling function, the entire stroke range of the vibration damper must be detected for a meaningful adjusting function.

It is thus an object of the present invention to allow the largest possible stroke range of the piston rod of a vibration damper to be detected by a simple and inexpensive sensor device.

### SUMMARY OF THE INVENTION

This object is met in that a floating body floats on a damping medium surface, and the floating body constitutes the sensor component that carries out a movement synchronous with the piston rod.

The damping medium surface, e.g., in the compensation chamber, changes as a function of the volume of the piston rod located in the working chamber. The position of the piston rod can be detected in an unambiguous manner by way of this functional relationship. The axial displacement path of the floating body is appreciably shorter than the displacement path of the piston. The displacement path of the floating body is determined from the ratio of piston rod diameter to compensation chamber diameter. The greater the diameter of the compensation chamber and the smaller the diameter of the piston rod, the shorter the displacement path of the floating body and the shorter the required length of the sensor component detecting the piston rod movement. The floating body need not float completely upon a damping medium surface, but can also be partially submerged.

In a further advantageous embodiment, the floating body is aligned at a wall of the compensation chamber with the sensor component on the cylinder side. A constant signal with respect to a position of the floating body is achieved by this step.

To keep the construction cost of the sensor device as low as possible, the floating body is constructed as an axially movable dividing piston with respect to a working chamber of the cylinder. The floating body or dividing piston can be used in a monotube-type or twin-tube-type vibration damper.

According to an advantageous embodiment, the floating body has an electrically conductive or magnetically conductive application. Floating bodies are often constructed as a plastic component. An additional element having the required technical characteristic is simply added in order to retain this advantageous type of construction.

A solution for a conductive application which is particularly suitable for large scale manufacture is achieved in that the floating body is at least partially coated.

The cylinder-side component of the sensor device is fastened to the outer side of the cylinder. No cable guide is needed into the cylinder of the vibration damper.

### BRIEF DESCRIPTION OF THE DRAWINGS

The invention will be described in more detail with reference to the drawings in which:

FIGS. 1-3 show a monotube-type vibration damper with a sensor device; and

FIG. 4 shows a twin-tube-type vibration damper with a sensor device

### DETAILED DESCRIPTION OF THE PRESENTLY PREFERRED EMBODIMENTS

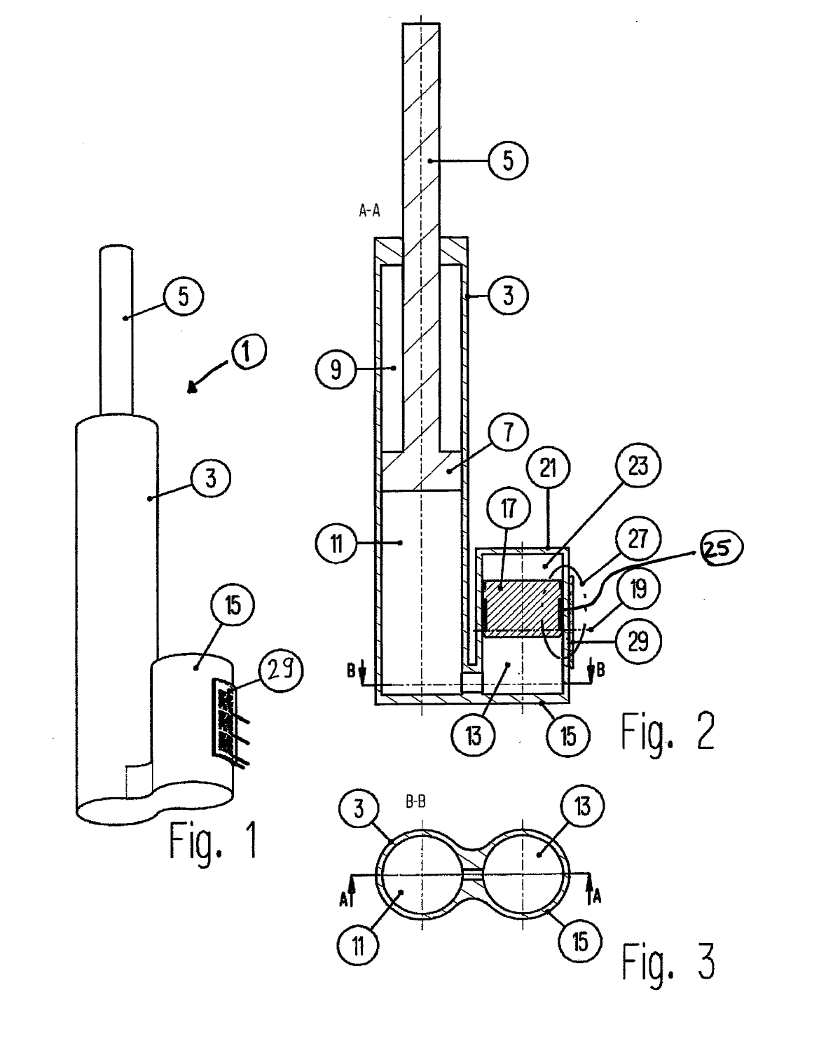

Viewed in conjunction, FIGS. 1 to 3 show a basic depiction of a monotube-type vibration damper 1. By monotube-type is meant that a single cylinder 3 is used, whose outer wall constitutes the outer surface of the vibration damper 1. Arranged in the cylinder 3 is an axially movable piston rod 5 carrying a piston 7 which is outfitted with damping valves, not shown, for damping an in-and-out movement of the piston rod and which divides the cylinder 3 into a working chamber 9 on the piston rod side and a working chamber 11 remote of the piston rod. The entire cylinder 3 is filled with an incompressible damping medium.

Axially in series or, in this case, adjoining the working chamber 11 remote of the piston rod, a compensation chamber 13 serves to receive the volume displaced by the movement of the piston rod. The compensation chamber 13 is formed in a storage housing 15 in which is arranged a floating body 17 that floats on a damping medium surface 19. A pressurized gas cushion 23 is provided between the floating body 17 and a cover 21 of the storage housing. A mechanical spring which preloads the floating body on the damping medium surface can be used by way of substitution. In a typical monotube vibration damper, the cylinder 3 also forms the storage housing.

The floating body 17 is constructed as a dividing body and extends over the entire cross section of the storage housing 15. Consequently, the floating body 17 positions itself at the wall of the compensation chamber 13 or storage housing 15.

The floating body 17 has an application 25 which comprises an electrically conductive or magnetically conductive material and accordingly forms a first component of a sensor device 27 which executes an axial movement synchronous with the piston rod. The application 25 on the floating body 17 is preferably formed as a partial coating.

A cylinder-side component 29 of the sensor device 27 is arranged on the outer side of the storage housing 15 or as part of the cylinder. Depending on the axial position of the floating body 17 relative to the cylinder-side component 29, which can be formed, e.g., by a circuit board with a plurality of coils according to EP 1 672 323 A1, the content of which is incorporated herein by reference in its entirety, a signal is provided which can be evaluated for determining the absolute position, the movement speed of the piston rod and movement direction of the piston rod.

As was already described, the compensation chamber 13 receives the damping medium volume displaced by the piston rod 5. FIGS. 1 to 3 show that the compensation chamber 13 has an appreciably larger cross section than the piston rod 5. If the diameter of the compensation chamber 13 is, e.g., twice as large as the diameter of the piston rod 5, the displacement path of the dividing piston 17 is smaller than the synchronous displacement path of the piston rod 5 by a factor of four. By this ratio, the cylinder-side sensor component 29 can be kept appreciably shorter and, therefore, less expensive than the solutions known from the prior art.

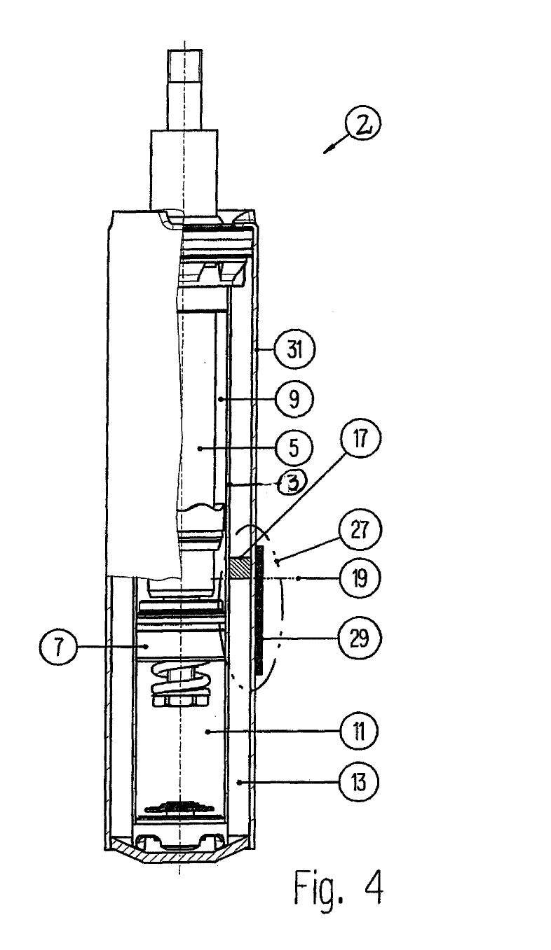

FIG. 4 shows a twin-tube-type vibration damper 2. In this case, the cylinder 3 is at least partially enclosed by an outer reservoir tube 31; the annular space formed in this way functions as a compensation chamber 13 which is partly filled with damping medium. An annular floating body 17, which need not perform a sealing function, floats on the damping medium surface 19. In this constructional form of the vibration damper, the level of the damping medium surface also changes exactly as a function of the damping medium volume displaced by the piston rod 5; that is, the damping medium surface rises when the piston rod 5 is moved deep into the cylinder 3, and the damping medium surface 19 falls when the piston rod 5 is moved out. This movement is transmitted from the floating body 17 to the cylinder-side component 29 of the sensor device 27 as described above.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. A vibration damper comprising:
a sensor device (27);
a cylinder (3) filled with damping medium;
a piston rod (5) guided within said cylinder so as to be axially movable and to displace a volume of damping medium;
a compensation chamber (13) for receiving at least the damping medium volume displaced by the piston rod (5);
said sensor device (27) comprising a first sensor component (29) stationary with respect to said cylinder (3) and a second component (17) constructed to carry out a movement synchronous with said piston rod (5), said second component (17) comprising a floating body (17) which floats on a damping medium surface (19) for carrying out the movement synchronous with said piston rod (5).

8. The vibration damper according to claim 7, wherein said floating body (17) is aligned at a wall of said compensation chamber (13) with said first sensor component (29) on the side of said cylinder.

9. The vibration damper according to claim 8, wherein said floating body (17) is constructed as an axially movable dividing piston with respect to a working chamber (9; 11) of said cylinder (3).

10. The vibration damper according to claim 7, wherein said floating body (17) comprises one of an electrically conductive and magnetically conductive application (25).

11. The vibration damper according to claim 10, wherein said floating body (17) is at least partially coated.

12. The vibration damper according to claim 7, wherein said cylinder-side first sensor component (29) of said sensor device (27) is fastened to the outer side of said cylinder.
